(19) United States
(12) Patent Application Publication
(10) Pub. No.: US 2023/0314760 A1
(43) Pub. Date: Oct. 5, 2023

(54) Athermal Mirror Mount

(71) Applicant: Michael J. Pero, King George, VA (US)

(72) Inventor: Michael J. Pero, King George, VA (US)

(73) Assignee: United States of America, as represented by the Secretary of the Navy, Arlington, VA (US)

(21) Appl. No.: 17/692,505

(22) Filed: Mar. 11, 2022

(51) Int. Cl. G02B 7/182

(52) U.S. Cl. CPC G02B 7/182

(57) ABSTRACT

A mirror-mount platform is provided for securing a mirror surface to a substrate to mitigate distortion from thermal expansion. The platform includes an annular back plate as the substrate composed of a first material, a mirror structure having an obverse reflective surface and a reverse attach surface, and a plurality of bracket assemblies that connect the back plate to the reverse attach surface. Each bracket assembly is composed of a second material that has a higher coefficient of thermal expansion than the first material.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to mirror mounts. In particular, the invention relates to design features for a mount to minimize stresses to a mirror.

Mirrors are used in a variety of optical applications for directing visible and infrared electromagnetic radiation to a focus point. Such mirrors are mounted onto a platform that provides structural support and direction aiming. Depending on the environment, such structures can experience changes in temperature, whether temporal and/or locally spatial.

Due to distinct thermal expansion coefficients inherent in a variety of structural materials, such expansion can induce stresses. For military applications, such thermal expansion of a mirror and/or a mirror mount causes physical distortions that lead to degraded focus of the mirror thereby decreasing lethality and imperiling the warfighter. Flexible mirror mounts result in low harmonic frequency and instability issues under operational conditions.

### SUMMARY

Conventional mirror mounts yield disadvantages addressed by various exemplary embodiments of the present invention. In particular, various exemplary embodiments provide a mirror-mount platform for securing a mirror surface to a substrate to mitigate distortion from thermal expansion. The platform includes an annular back plate as the substrate composed of a first material, a mirror structure having an obverse reflective surface and a reverse attach surface, and a plurality of bracket assemblies that connect the back plate to the reverse attach surface. Each bracket assembly is composed of a second material that has a higher coefficient of thermal expansion than the first material.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and various other features and aspects of various exemplary embodiments will be readily understood with reference to the following detailed description taken in conjunction with the accompanying drawings, in which like or similar numbers are used throughout, and in which:

FIG. 1 is a perspective assembly view of a mount assembly;

FIG. 2 is a perspective exploded view of the assembly components;

FIG. 3 is a perspective view of a back plate;

FIG. 4 is a perspective view of a ball joint support;

FIG. 5 is a perspective view of an extension support;

FIGS. 6A and 6B are perspective views of a mirror;

FIG. 7 is an elevation view of the mount assembly; and

FIG. 8 is an elevation view of thermal expansion forces.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

The disclosure generally employs quantity units with the following abbreviations: length in inches (”) or feet (’) or meters (m), mass in grams (g), time in seconds (s), angles in degrees (°), force in newtons (N), temperature in degrees Celsius (°C), energy in joules (J), and frequencies in gigahertz (GHz. Supplemental measures can be derived from these, such as coefficient of thermal expansion (CTE) of linear elongation per length in response to temperature increase in µm/m°C and the like.

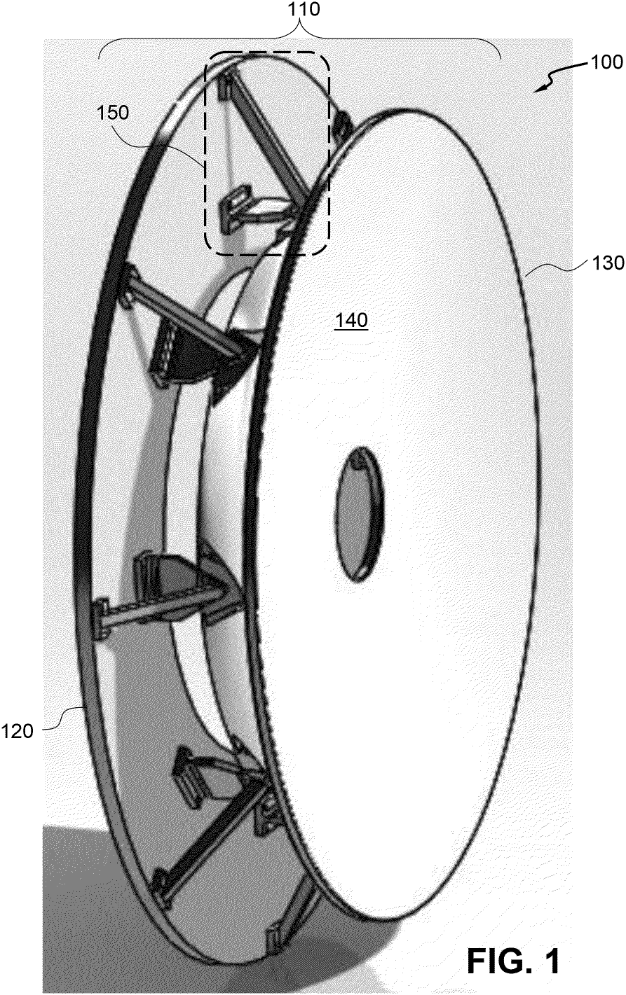

FIG. 1 shows a perspective assembly view 100 of an exemplary rigid athermal mirror-mount combination 110 that includes an annular back plate 120 for supporting a parabolic mirror 130 with circular periphery having a reflective receiving surface 140 covering about 13.5 square feet for a prototype. The mirror 130 attaches to the back plate 120 by bracket assemblies 150 angularly distributed onto the back plate 120.

The back plate 120 as a mounting substrate is preferably composed of Ti-6Al-4V titanium alloy, whose linear coefficient of thermal expansion (CTE) is 8.5 µm/m°C. The mirror 130 is preferably composed of silicon carbide (SiC), whose CTE is 2.77 µm/m°C. The materials are exemplary to minimize production cost and not limiting. The coating for the receiving surface 140 should have appropriate specular reflection properties.

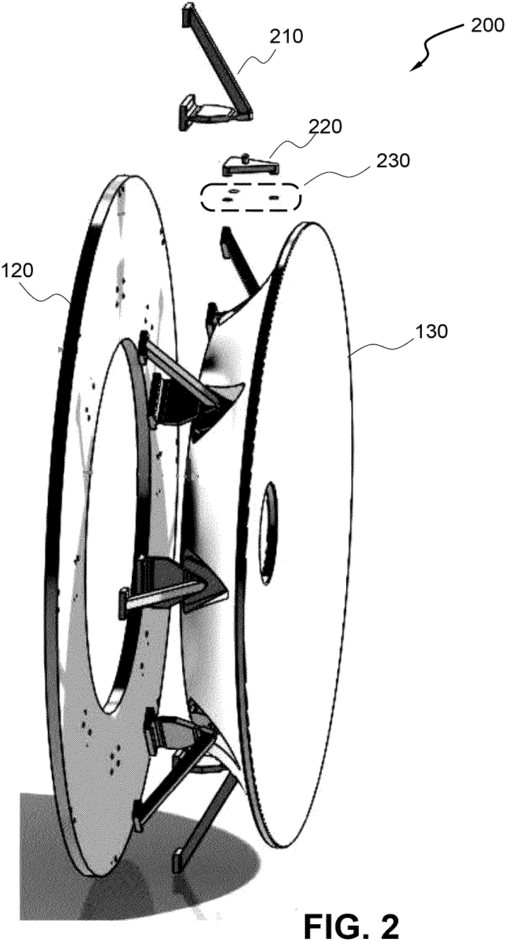

FIG. 2 shows a perspective exploded view 200 of components for the mirror-mount combination 110. Each bracket assembly 150 includes an extension support 210, a ball joint support 220 and adhesive fasteners 230. Each extension support 210 connects to the back plate 120 at inner and outer radial positions. Each ball joint support 220 connects the extension support 210 to the mirror 130. The extension and ball joint supports 210 and 220 are composed of aluminum alloy Al 6061-T6, whose CTE is 22 µm/m°C.

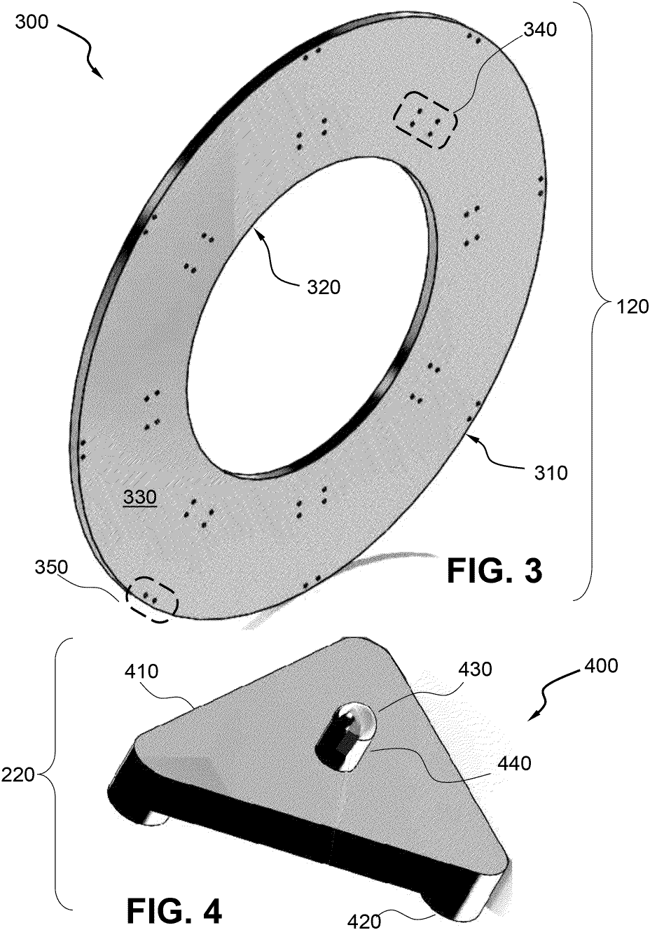

FIG. 3 shows a perspective view 300 of the annular back plate 120, forming a flat ring. The back plate 120 has an outer diameter 310 and an inner diameter 320. In this example, the back plate 120 includes eight annularly distributed series of holes: a rectangular set of four holes 340 that extend radially outward from the inner diameter 320, and a set of two holes 350 that extend near the inner periphery of the outer diameter 310. These holes enable insertion of bolts to fasten the extension support 210 to the back plate 120. Artisans of ordinary skill will recognize that the octagonal distribution of support attachments is exemplary only, and not intended to be limiting of comparable arrangements.

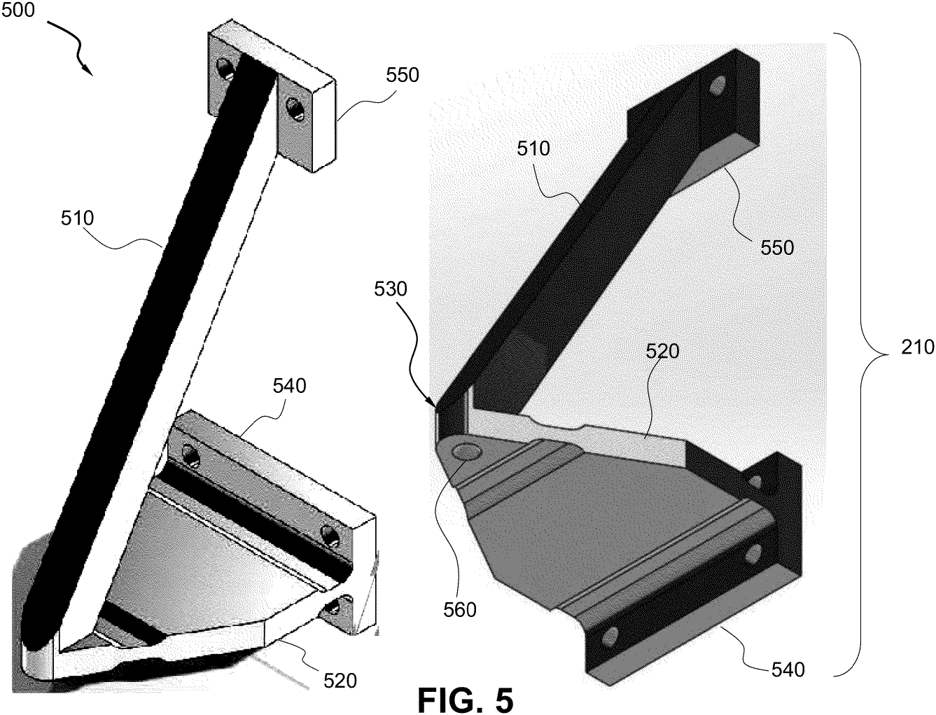

FIG. 4 shows a perspective view 400 of the ball joint support 220. A flat triangular platform 410 supported by corner pads 420 on the reverse side supports a hemispheric tip 430 extending from a post 440 on the obverse side. The pads 420 attach to the mirror 130 via the adhesive 230, while the hemispheric tip 430 attaches to the extension support 210.

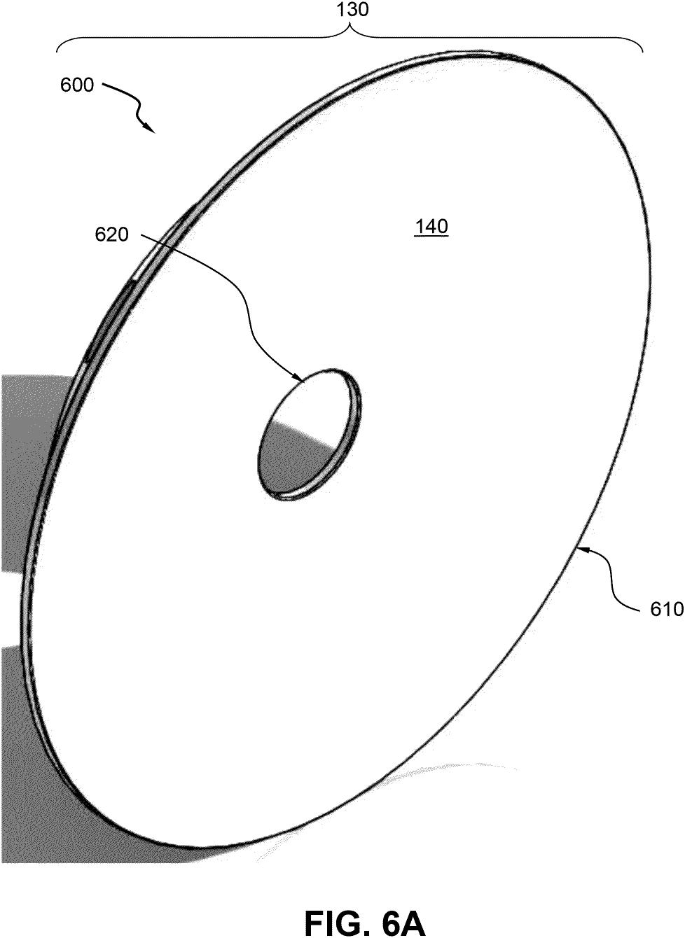

FIG. 5 shows perspective views 500 of the extension support 210. An arm 510 connects to a stem 520 at an elbow joint 530 at their proximal ends. The stem 520 and arm 510 attach to flanges 540 and 550 at their respective distal ends. The outer flange 540 includes a rectangular set of holes that align with the set 340 on the back plate 120, while the inner flange 550 includes a pair of holes that align with the set 350 on the back plate 120.

The stem 520 at or near the elbow joint 530 includes a concave recess 560 that receives the hemispheric tip 430 of the ball joint support 220, which connects to the mirror 130 by the adhesives 230. Typically the arm 510 and outer flange 540 can be formed as a unitary item, and similarly the stem 520 and inner flange 550 can be similarly unified. The arm 510 and the stem 520 can be formed as a unitary item or as separate components, depending on manufacturing convenience.

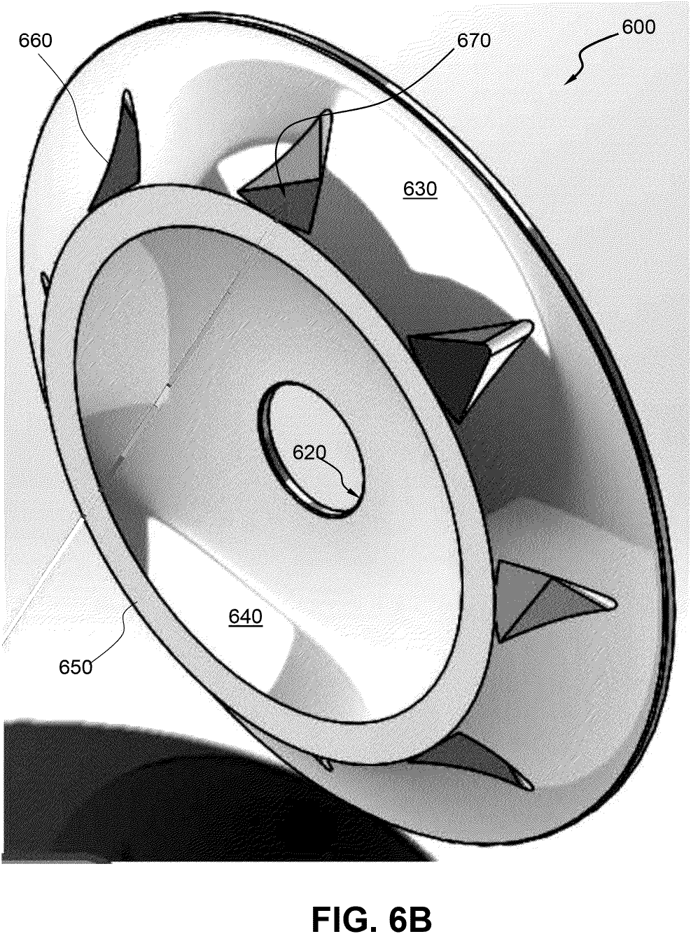

FIGS. 6A and 6B show respective perspective views 600 of obverse and reverse sides of the mirror 130. The parabolic surface 140 on the obverse side of the mirror 130 terminates at an outer circular periphery 610 and an inner circular periphery 620. The reverse side features an outer hyperbolic curve surface 630 and an inner convex (elliptical) surface 640. The outer surface 630 resembles a truncated aerospike plug. A flat rim 650 joins the outer and inner surfaces 630 and 640.

The outer surface 630 includes an angular distribution of wedge cutouts 660 for receiving the elbow joints 530 of the extension supports 210. At its radial periphery, each cutout 660 has a flat landing surface that engages the pads 420 of a corresponding ball joint support 220 by the adhesives 230.

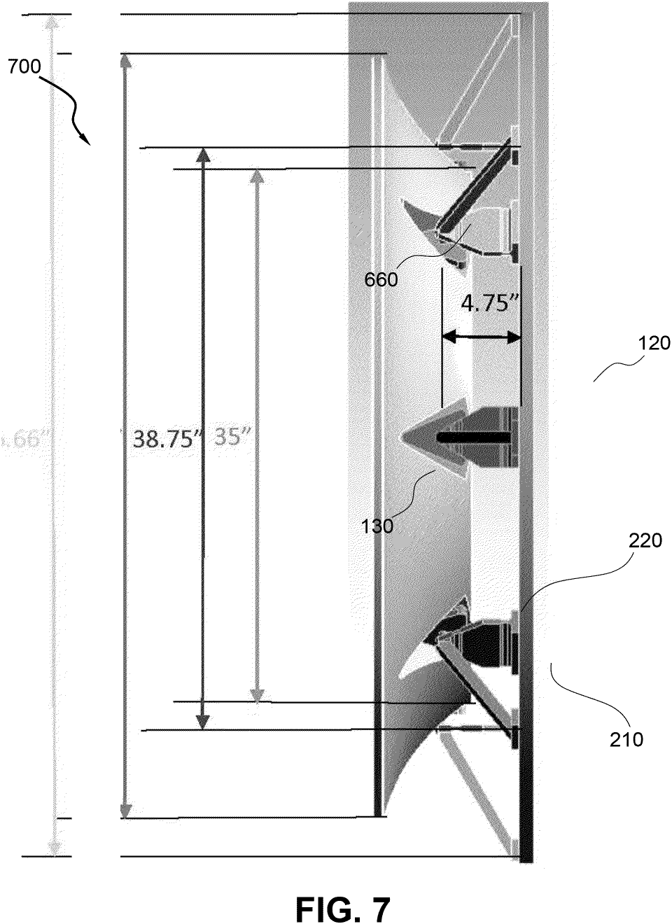

FIG. 7 shows an elevation view 700 of the mirror-mount combination 110 with example dimensions. For example for a mirror 130 having a 50″ diameter of outer periphery 610, the distance from the hemispheric tip 420 and its corresponding recess 560 inserted into its corresponding cutout 660 to the back plate 120 is 4.75″. These dimensions are exemplary only and not limiting.

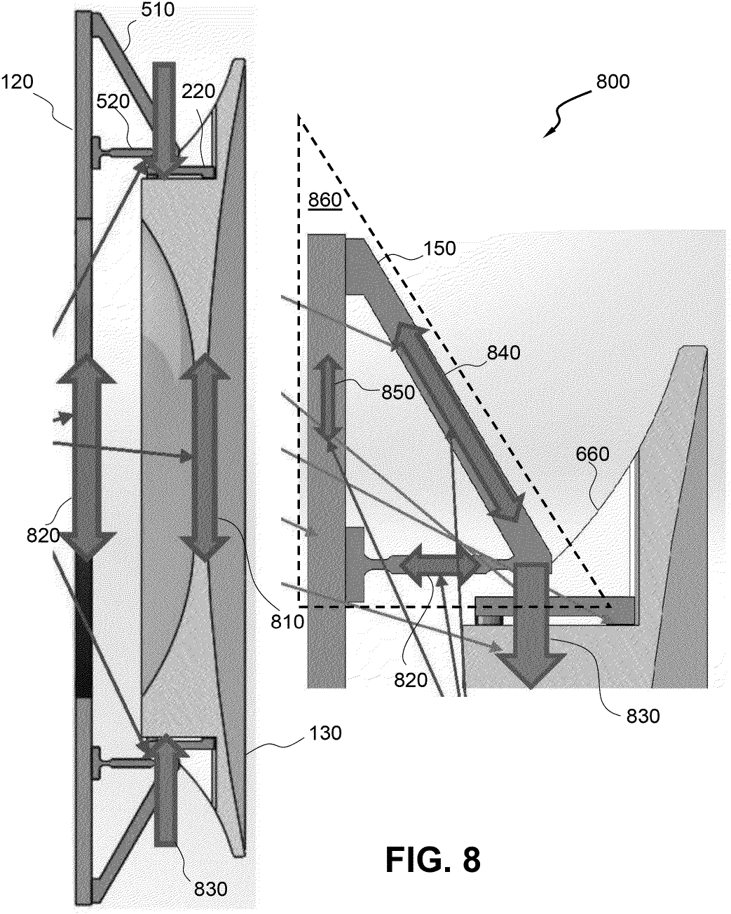

FIG. 8 shows elevation detail views 800 of compressive and tensile forces on the mirror-mount combination 110. As the mirror 130 heats, thermal expansion causes the outer periphery 610 to lengthen and inducing radially outward stresses 810. Similarly, as the back plate 120 heats, thermal expansion causes the ring’s outer diameter 310 to lengthen, leading to radially outward stresses 820. To compensate, the extension supports 210 also expand, producing radially inward forces 830 that counteract the mirror’s radially outward forces 810.

In particular, the expansion of the arm 510 yields tension 840 along with the stem 520 that yields tension 850 combine with the stresses 820 from the back plate 120 to produce the counteracting inward forces 830. Thus, thermal expansion of the mirror 130 is thereby counter-balanced by a combination of forces from the back plate 120 and the bracket assemblies 150. The geometric combination of the back plate 120, arm 510 and stem 520 forms a triangular restraint 860 that restrains thermal expansion of the mirror 130.

Exemplary embodiments provide a mirror-mount combination 110 as a concept design capable of supporting a heavy mirror 130 while maintaining athermal-rigidity. Conventional mirror-mount concepts use mount flexibility designs or low thermal expansion materials such as the nickel-iron alloy called invar (64FeNi) to athermalize.

Mount flexibility induces low frequency harmonic resonance leading to instability under operational conditions. Conventional flexible designs tend to be complicated to machine and manufacture. Athermal materials (i.e., with low coefficients of thermal expansion) such as invar experiences structural creep over time, reducing its effectiveness after fielding. In addition, invar tends to be expensive and difficult to machine.

This exemplary design concept utilizes easily machined materials with geometric triangular restraint 860 to maximize rigidity and minimize stress on the mirror 130. These bimetallic triangular restraints 860 enable controlled expansion calculated to expand at the desired deflection based on geometry.

Calculations are provided to design mount such that mount interface expands linearly with the expansion of the mirror 130. The calculations for this expansion based on this concept enable triangular restraints 860 to be designed such that the growth difference between the back plate 120 and mirror 130 is sufficiently small to be absorbed by the adhesive 230.

For the purpose of a conceptual prototype, the following materials are proposed: aluminum alloy Al 6061-T6 for the supports 210 and 220, titanium alloy Ti-6Al-4V (Grade 5) for the back plate 120, and silicon carbide for the mirror 130. Titanium and aluminum are commonly machined and available materials. Silicon carbide is a common mirror substrate, but imposes challenges due to its high coefficient of thermal expansion (CTE) compared to other materials for this purpose such as lithium-aluminosilicate glass ceramic with CTE of 0.05 µm/m°C. Schott AG produces this material under ZERODUR^{®} for telescopes. However, in contrast to comparatively strong, stiff and durable silicon carbide, such alternate low-CTE ceramics are subject to undesirable flex distortions. Hence, silicon carbide is used as the mirror’s substrate in the exemplary concept as a worst-case scenario. Controlled growth enables the combination 110 to remain rigid without causing excessive stress concentrations on the mirror 130.

Because titanium has a much lower CTE than aluminum, triangular geometry causes the interfaces between the mirror 130 and the support assemblies 150 to grow inward with thermal expansion. For optical systems, the back plate 120 is either held stationary or electronically actuated. Interfaces at the eight support assemblies 150 include the expansion support 210, the ball joint support 220, adhesive 230, the back plate 120, and the mirror 130.

Minimal expansion occurs on the back plate 120 between its angular expansion and horizontal flexure due to the low CTE of titanium. By contrast, the angular expansion from the arm 510 and the horizontal flexure from the stem 520 of the expansion support 210 experiences high growth due to its length as well as the high CTE of aluminum. In addition, the horizontal flexure experiences a mild amount of thermal expansion because of its high aluminum CTE, but along a short growth area. This combination produces an overall inward growth of the expansion support 210. The exemplary rigid athermal mirror-mount combination 110 provides triangular restraint 860 by force balancing to counteract part of the thermal growth of the back plate 120 and result in the overall expansion of supports 210 and 220 to match the expansion of the mirror 130.

Design concept considers a 50″ diameter mirror 130 with 35″ across mount flat surfaces 670 in the cutouts 660, a 4.75″ distance by the stems 520 with a 38.75″ diameter bolt pattern in set 340 for the horizontal flexures. Analysis revealed that having a 49.85″ diameter mount pattern in set 350 for the arm 510 on the expansion support 210 results in an expansion difference of 1.31E-06″ (at +50° C. from room temperature ambient), which is easily absorbed by adhesive 230. The arm 510 forms an angular expander, providing rigid support for the mirror 130 as well as inward expansion to counteract thermal growth of the back plate 120. The stem 520 exhibits horizontal flexure.

This exemplary combination 110 provides a rigid lateral support for the mirror 130 while permitting inward motion due to the thinned out flexible areas on each end. Because this area is shorter than the arm 510, the majority of thermal growth is inward as shown by the tension 850. The concave recess 560 of the expansion support 210 connects to the hemispheric tip 430 on the ball joint support 220. This ball-and-socket interface eliminates any torque transmission from the back plate 120 to the mirror 130 throughout the thermal expansion process. The location of the hemispheric tip 430 relative to the pads 420 is designed to evenly distribute pressure load to each of the three pads 420. The pads 420 attach to the radial surfaces 670 on the mirror 130 using an epoxy adhesive 230.

Bolt holes on flanges 530 and 540 fasten the expansion support 210 to respective hole sets 330 and 340 on the back plate 120. Flat radial surfaces 670 of the cutouts 660 on the mirror 130 are used to fasten pads 420 on the ball joint support 220 using an adhesive 230. Thus, the rigid athermal mirror-mount combination 110 is designed for the expansion supports 210 to counteract part of the thermal growth of the back plate 120 and result in the overall expansion of the supports 210 and 220 to match the expansion of the mirror 130 itself.

This minimizes the effect of thermal expansion on the back plate 120 between the arm 510 and the stem 520 due to the low CTE of titanium. By contrast, the angular expansion in the arm 510 experiences high growth due to its length as well as the high CTE of aluminum. In addition, the horizontal flexure in the stem 520 experiences a mild amount of thermal expansion due to aluminum’s high CTE, but a short growth area. This results in an overall inward growth of the expansion support 210.

Thermal expansion calculator was developed in MS Excel to calculate the expansion difference between the mirror and mirror mount with this design. Calculation first applies specified CTE values and temperature changes to corresponding materials and components to determine new length. With new length and angles of triangular restraints 860, calculation determines distance from plate-to-mirror attachments 150 to ensure expansion is the same between the mirror 130 and the back plate 120.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A mirror-mount platform for securing a mirror surface to a substrate to mitigate distortion from thermal expansion, said platform comprising:
an annular back plate as the substrate composed of a first material;
a mirror structure having an obverse reflective surface and a reverse attach surface; and
a plurality of bracket assemblies that connect said back plate to said reverse attach surface, each bracket assembly composed of a second material having a higher coefficient of thermal expansion than said first material.

2. The platform according to claim 1, wherein said reverse attach surface includes a plurality of cavities corresponding to said plurality of bracket assemblies.

3. The platform according to claim 2, wherein said each bracket assembly comprises:
a ball joint support having radially inner and outer sides, said outer side including pads that engage a corresponding cavity on said reverse attach surface via adhesive, said inner side extending a hemispheric tip;
a stem having a concave recess for receiving said hemispheric tip and an inner flange for bolting to said back plate; and
an arm having an outer flange for bolting to said back plate and connecting to said stem proximal to said concave recess.

4. The platform according to claim 1, wherein said mirror structure is composed of silicon carbide, said bracket assembly is composed of an aluminum alloy, and said back plate is composed of a titanium alloy.
